(19) United States
(12) Patent Application Publication
(10) Pub. No.: US 2015/0100422 A1
(43) Pub. Date: Apr. 9, 2015

(54) SYSTEM AND METHOD FOR PROMOTING A PROFILE OF A PARTICULAR USER IN A NETWORK ENVIRONMENT

(71) Applicant: MATCH.COM, L.L.C., Dallas, TX (US)

(72) Inventors: Tom R. Quisel, New York, NY (US); Michael George Maxim, Bronx, NY (US)

(73) Assignee: MATCH.COM, L.L.C., Dallas, TX (US)

(21) Appl. No.: 14/048,765

(22) Filed: Oct. 8, 2013

(51) Int. Cl. G06Q 30/02

(52) U.S. Cl. CPC G06Q 30/0256; G06Q 30/0273
USPC 705/14.54; 705/14.49

(57) ABSTRACT

A method is provided in one example embodiment and includes identifying a user in a computer-implemented matching system as having paid a fee for additional promotion of the identified user during a promotional period; and, during the promotional period, providing impressions for the identified user in accordance with an impression probability calculated to achieve a promotional target with respect to the user, wherein the impressions comprise presenting the identified user to other users in the computer-implemented matching system. In one embodiment, the promotional target comprises a target number of visits by other users to a profile of the identified user during the promotional period. In another embodiment, the promotional target comprises a target number of impressions for the identified user during the promotional period.

### TECHNICAL FIELD

This disclosure relates in general to the field of communications and, more particularly, to a system and a method for promoting the profile of a particular user in a network environment, such as an online matching system environment.

### BACKGROUND

Communications network architectures have experienced significant notoriety because they can offer the benefits of automation, convenience, and data management for their respective online communities. Certain network protocols may be used in order to allow an end user to be matched to other end users or to scenarios in which they stand to benefit (e.g., job searches, person-finding services, real estate searches, online dating, etc.).

In the case of an online dating service, for example, an end user will typically be prompted to specify a variety of preferences to be used in matching the end user with other end users in a particular online dating community. The information each end user provides about him or herself may be viewed by other end users in the online community in determining whether to interact with that end user. In certain cases, the actual dating platform can participate in matching activities. This interventionist involvement can often spur or provoke new relationships being formed.

### BRIEF DESCRIPTION OF THE DRAWINGS

To provide a more complete understanding of the present disclosure and features and advantages thereof, reference is made to the following description, taken in conjunction with the accompanying figures, wherein like reference numerals represent like parts, in which:

FIG. 1 is a network diagram showing an operating environment of the present disclosure in accordance with one embodiment of the present disclosure;

FIGS. 2A-J are simplified screen shots of an example protocol for participating in an on-line dating service in accordance with one embodiment of the present disclosure;

FIG. 3 is a flow diagram illustrating logic implemented by a pay-for-promotion (“PFP”) feature of an on-line dating service, such as illustrated in FIGS. 1-2J, in accordance with one embodiment of the present disclosure;

FIG. 4 is a flow diagram illustrating logic implemented by the PFP feature of FIG. 3 for generating match results in accordance with one embodiment of the present disclosure; and

FIG. 5 is a flow diagram illustrating logic implemented by the PFP feature of FIG. 3 for implementing a promotion impression controller loop in accordance with one embodiment of the present disclosure.

### DETAILED DESCRIPTION OF EXAMPLE EMBODIMENTS

### Overview

A method is provided in one example embodiment and includes identifying a user in a computer-implemented matching system as having paid a fee for additional promotion of the identified user during a promotional period; and, during the promotional period, providing impressions for the identified user in accordance with an impression probability calculated to achieve a promotional target with respect to the user, wherein the impressions comprise presenting the identified user to other users in the computer-implemented matching system. In one embodiment, the promotional target comprises a target number of visits by other users to a profile of the identified user during the promotional period. In another embodiment, the promotional target comprises a target number of impressions for the identified user during the promotional period. An “impression” may include any time a promoted user is shown because of the promotion. An impression may occur in various areas of the matching system's web site, including match results, a list of recommended profiles, etc. A “visit” occurs when a user opens, accesses, clicks on, views, or otherwise interacts with or evinces an intent to interact with another user or the user's profile via the matching system. “Promotion” of a user comprises increasing a number of impressions for the user.

The method may further comprise, during the promotional period, updating the impression probability based on an actual number of impressions for the user during a previous time period relative to the promotional target. The method may still further include, upon expiry of the promotional period, determining whether the user has paid for promotion of the user during an additional promotional period; and, if the user has not paid for promotion of the user during the additional time period, ceasing the providing impressions for the user.

In some embodiments, providing impressions comprises injecting a profile of the user into search results of other users. In other embodiments, providing impressions comprises displaying a profile picture of the user in a featured area of a web page viewed by another user. In still other embodiments, the method comprises offering a subscription to a website-based service in exchange for a fee, wherein the website is configured to provide one or more results associated with ranking a set of like user profiles.

### EXAMPLE EMBODIMENTS

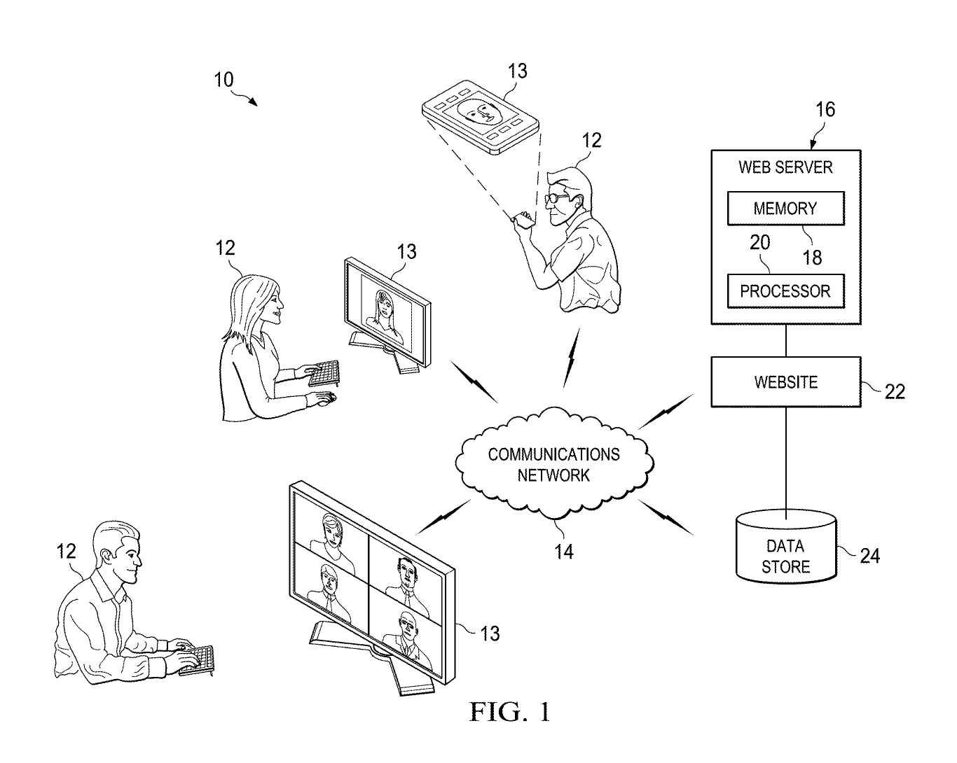

FIG. 1 is a simplified block diagram of a system 10 for facilitating an online dating scenario in a network environment. In other embodiments in which communications or matching is valuable, system 10 can be leveraged to identify and to evaluate suitable candidates in other areas (e.g., hiring/employment, recruiting, real estate, general person searches, etc.). FIG. 1 includes multiple end users 12 and endpoints 13, a communications network 14, a web server 16 comprising memory 18 and a at least one processor 20, a website 22, and a data store 24. Data store 24 may be any type of mechanism for storing data, including but not limited to one or more files, databases, memory devices, mass storage devices, data centers, etc. System 10, users 12 interact with web server 16 via endpoints 13, each of which comprises an appropriate user interface for interacting with web server 16 via website 22 for facilitating functions and features described herein. In certain example implementations, website 22 and web server 16 are consolidated into a single component, physical structure, equipment, etc.

FIG. 1 may be configured such that inter- and intra-communications are readily achieved by any of the components included therein. The present disclosure is capable of providing both an online component (as illustrated in FIG. 1) and an off-line component such that one or more end users can meet, gather information, resolve to meet, and then subsequently meet in person with the assistance of system 10. Ancillary components to such a comprehensive process may involve pre-date profiles, post-date follow-ups, and a myriad of other significant features, some of which are outlined in detail below.

End users 12 may include a variety of types of end users, such as clients, customers, prospective customers, or entities wishing to participate in an online dating scenario and/or to view information associated with other participants in the system. End users 12 may also seek to access or to initiate communications with other end users that may be delivered via communications network 14. End users 12 may review data (such as user profiles, for example) associated with other users in order to make matching decisions or selections. Data, as used herein in this document, refers to any type of numeric, voice, video, or script data, or any other suitable information in any appropriate format that may be communicated from one point to another.

End users 12 may access the aforementioned data via endpoints 13, which may be inclusive of devices used to initiate a communication. Note that the broad term “user” encompasses any type of node or user device, or any type of endpoint discussed herein. Additionally, the term “user” can further include any type of profile to be used in the system discussed herein. Hence, the term “user” can include (but is not limited to) elements such as a computer, a personal digital assistant (PDA), a laptop or electronic notebook, a cellular telephone, an IP telephone, an iPhone™, an iPad™, a Microsoft Surface™, an Android™ phone, a Google Nexus™, or any other device, component, element, or object capable of initiating voice, audio, or data exchanges within communication system 10. The endpoints may be inclusive of a suitable interface to the end user 12, such as a microphone, a display, or a keyboard or other terminal equipment. Endpoints 13 may also include any device that seeks to initiate a communication on behalf of another entity or element, such as a program, a database, or any other component, device, element, or object capable of initiating a voice or a data exchange within communication system 10. In addition, each of the endpoints 13 may be a unique element designed specifically for communications involving system 10. Such an element may be fabricated or produced specifically for matching applications involving end user 12 and endpoint 13.

A user may employ any device capable of operating as an endpoint 13 to connect to communications network 14 via wire, wireless, cellular, satellite link or other suitable interfaces. Web server 16, which as previously noted includes memory 18 and at least one processor 20, hosts website 22 and has access to transmit and receive user or presence data (e.g., user profile data, user and/or user endpoint data, user contact data) from database 24. Presence data may be collected, aggregated, and utilized as required to facilitate communications between endpoints 12 over communications network 10 or other outside communication systems. Presence data may also include information and/or instructions enabling the creation, duration, and termination of communication sessions between diverse endpoints 13 that utilize different communication and/or networking protocols.

Communications network 14 is a communicative platform operable to exchange data or information emanating from endpoints 13. Communications network 14 represents an Internet architecture in a particular embodiment of the present disclosure, which provides end users 12 with the ability to electronically execute or to initiate actions associated with finding a potential match candidate. Alternatively, communications network 14 could be a plain old telephone system (POTS), which end user 12 could use to perform the same operations or functions. Such transactions may be assisted by management associated with website 22 or manually keyed into a telephone or other suitable electronic equipment. In other embodiments, communications network 14 could be any packet data network (PDN) offering a communications interface or exchange between any two nodes in system 10. Communications network 14 may alternatively be any local area network (LAN), metropolitan area network (MAN), wide area network (WAN), wireless local area network (WLAN), virtual private network (VPN), intranet, or any other appropriate architecture or system that facilitates communications in a network or telephonic environment.

In one embodiment, web server 16 comprises a server that is operable to receive and to communicate information to one or more end users 12. In a generic sense, web server 16 can implement a computer-implemented matching system that provides a framework for suitable matching activities. Alternatively, web server 16 may be any switch, router, gateway, cache, server blade, software, processor, proprietary component, object, module, or element (or any combination of these) operable to facilitate communications involving end user 12. Web server 16 may be integrated with database 24 and/or website 22, where any one or more of these elements may share or otherwise coordinate the activities discussed herein.

In one particular embodiment, web server 16, via interaction with database 24 and/or in conjunction with website 22, is engaged in facilitating interaction(s) between parties interested in seeking a romantic partner (i.e., online dating). For example, website 22 can be online dating service provider www.Match.com, www.Chemistry.com, www.okcupid.com, or any other suitable provider. In certain example scenarios, a given end user may pay a fee for a subscription-based service (and potentially, only those users would qualify to be eligible to participate in events in certain example implementations, although other example embodiments involve non-members being eligible for participation). Additionally, certain end user fee structures may apply to different tiers of service: some of which may entitle an end user to enhanced features on website 22 (e.g., the ability to communicate more frequently with other users, additional matches being provided (potentially, more frequently) to an end user who paid the higher fee structure, the ability to store data, the ability to share data, the ability to upload additional information, the ability to target specific searches based on particular criteria, the ability to receive preferential positioning in the context of being matched to other users, the ability to perform video calls (e.g., Skype, etc.) with other users, the ability to perform audio calls with other users, etc.).

In certain embodiments, website 22 is a computer-implemented matching system, which may be any website or architecture provided for facilitating a connection involving two or more people, and which may make use of a given profile, photograph, resume, article description, etc. This could include services associated with job placements, escort services, auction services, social media, real estate listings, recruiting services (e.g., in athletics, academia, employment scenarios, instances involving the sales of goods and services), etc.

Considerable flexibility is provided by the structure of web server 16 and website 22 in the context of system 10. Thus, it can be easily appreciated that such functions could be provided external to web server 16 or website 22. In such cases, such a functionality could be readily embodied in a separate component, server, processor, device, or module. Note that these online dating features and capabilities may be provided in just one of these elements, in both, or distributed across both of them. Hence, in certain embodiments, the online dating operations may be consolidated in a single website, where no redirection is needed, nor performed for the user.

In operation of an example embodiment, consider a case where a given end user is interested in participating in an online dating scenario. End user 12 can access website 22 via the communications network 14 (which in the example presented comprises the Internet) using endpoint 13, register, and create a profile on the site. Moreover, end user 12 can access website 22 through any suitable banner, pop-up, partnership, e-mail solicitations, direct mailings, etc. It can be appreciated that online commerce can be generated by a plethora of marketing tools and any such tools can readily cooperate with the operations of the present disclosure.

At this point, matching of any form can commence amongst the members of the online community. For example, in the context of a romantic endeavor, a person may begin the dating process or engage in communications that would spawn such dating. Other applications could include job applicants who are being sought by employers. Any of the individuals who reside in the online community can begin using any of the tools or capabilities of the platform.

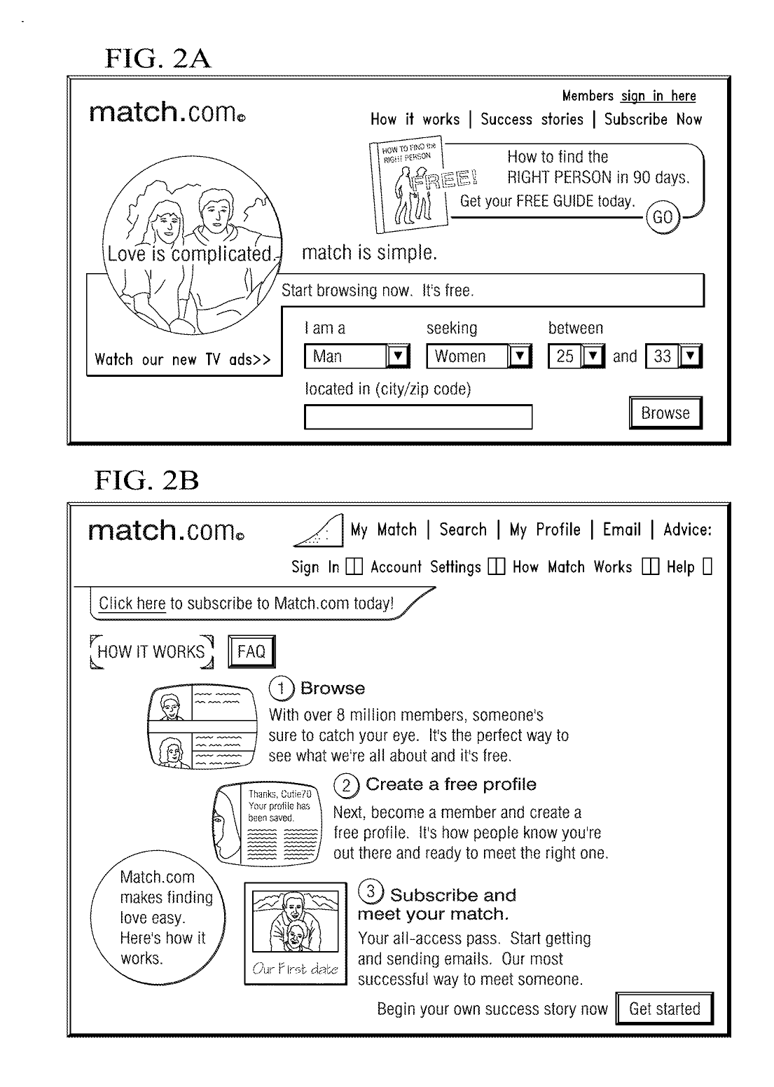

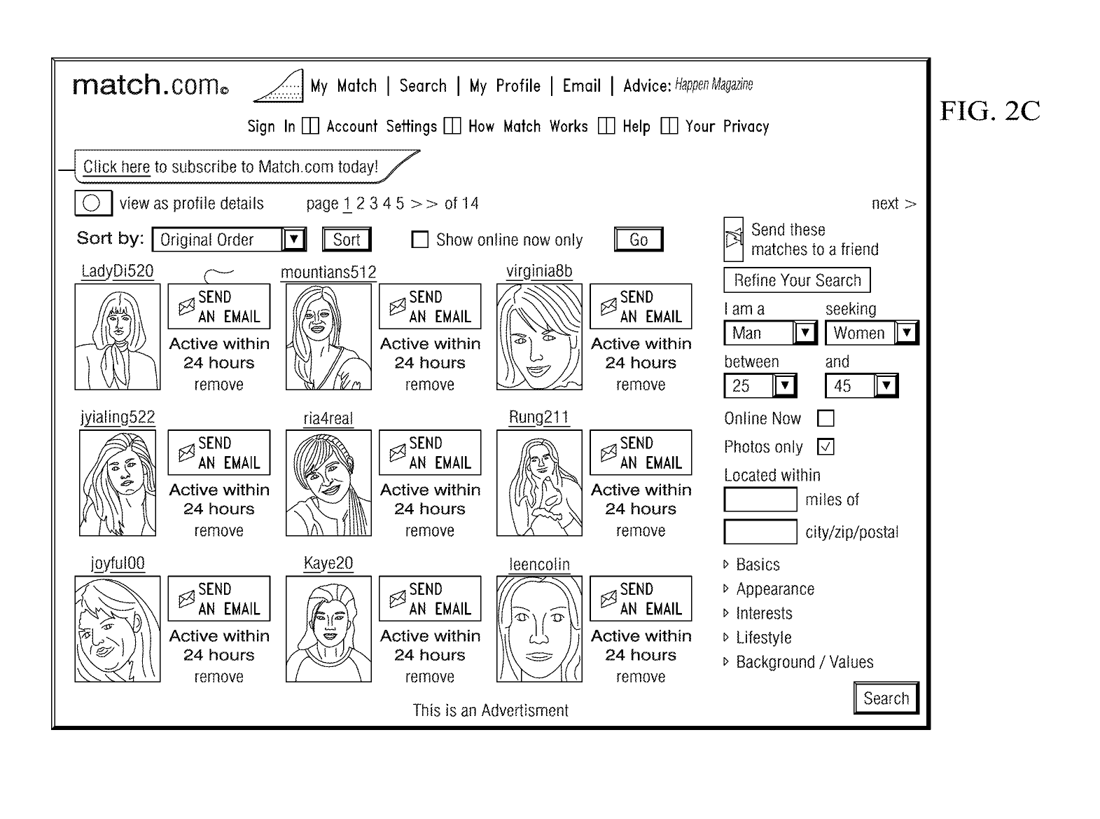

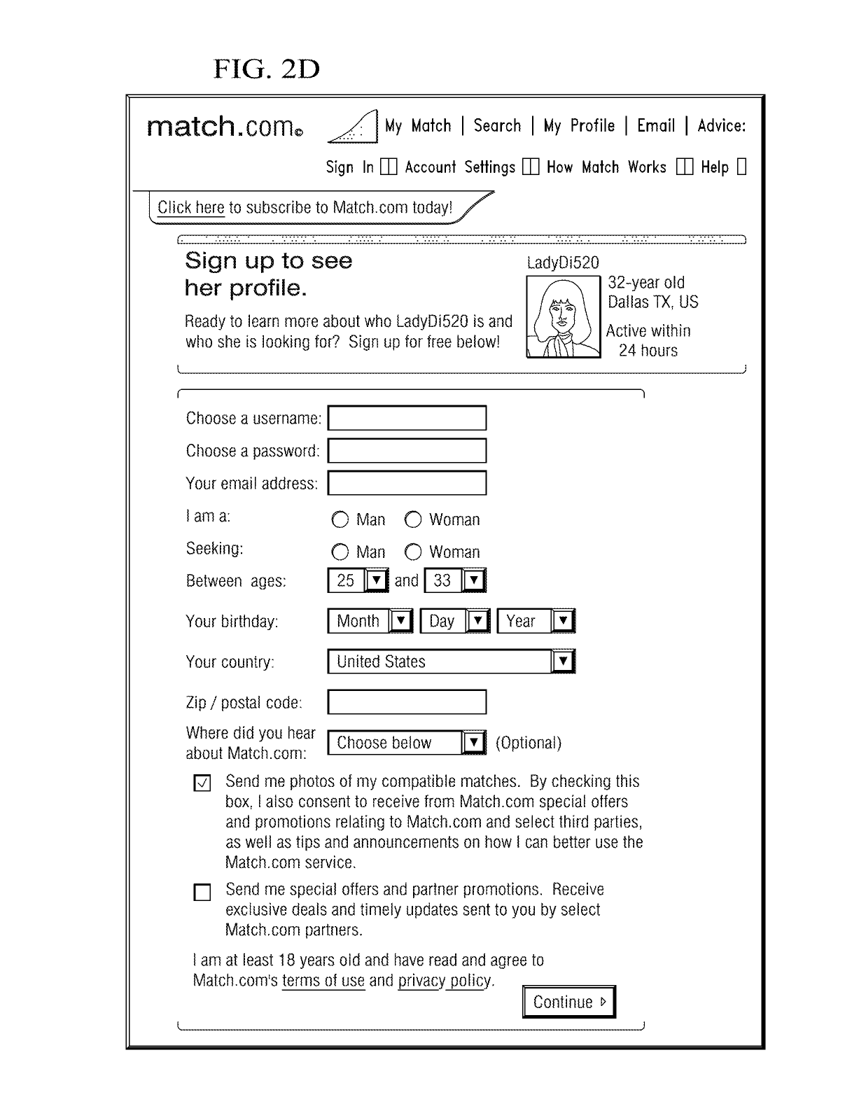

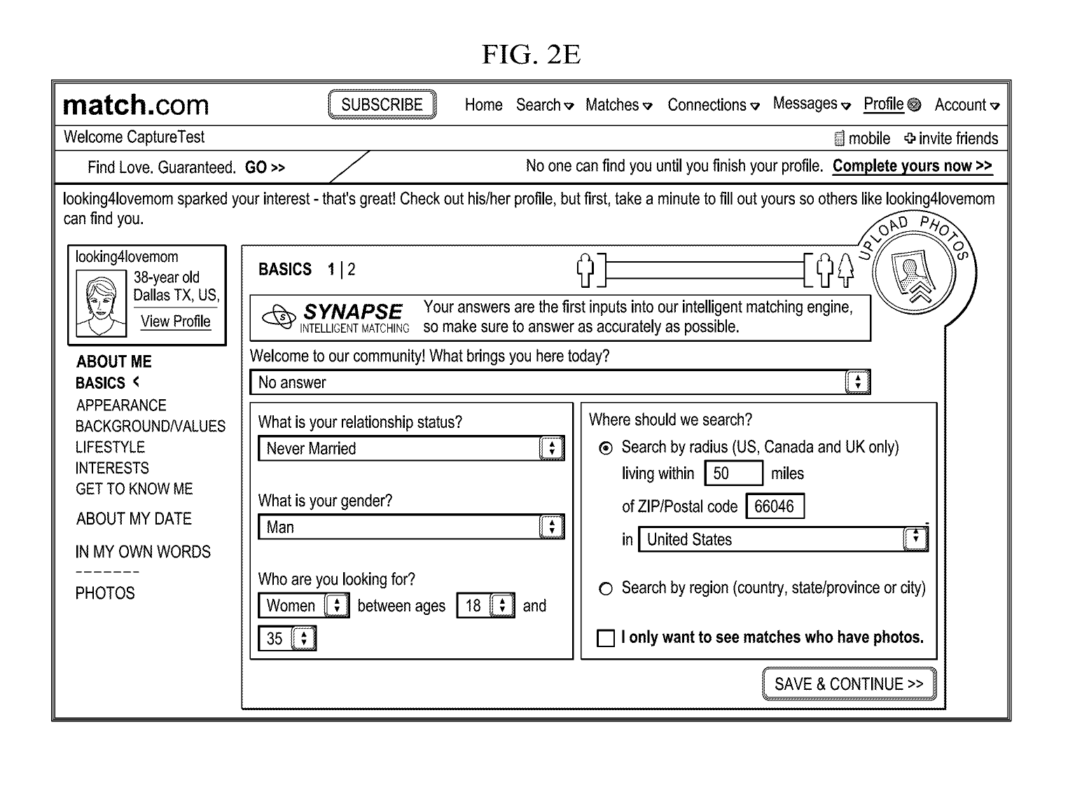

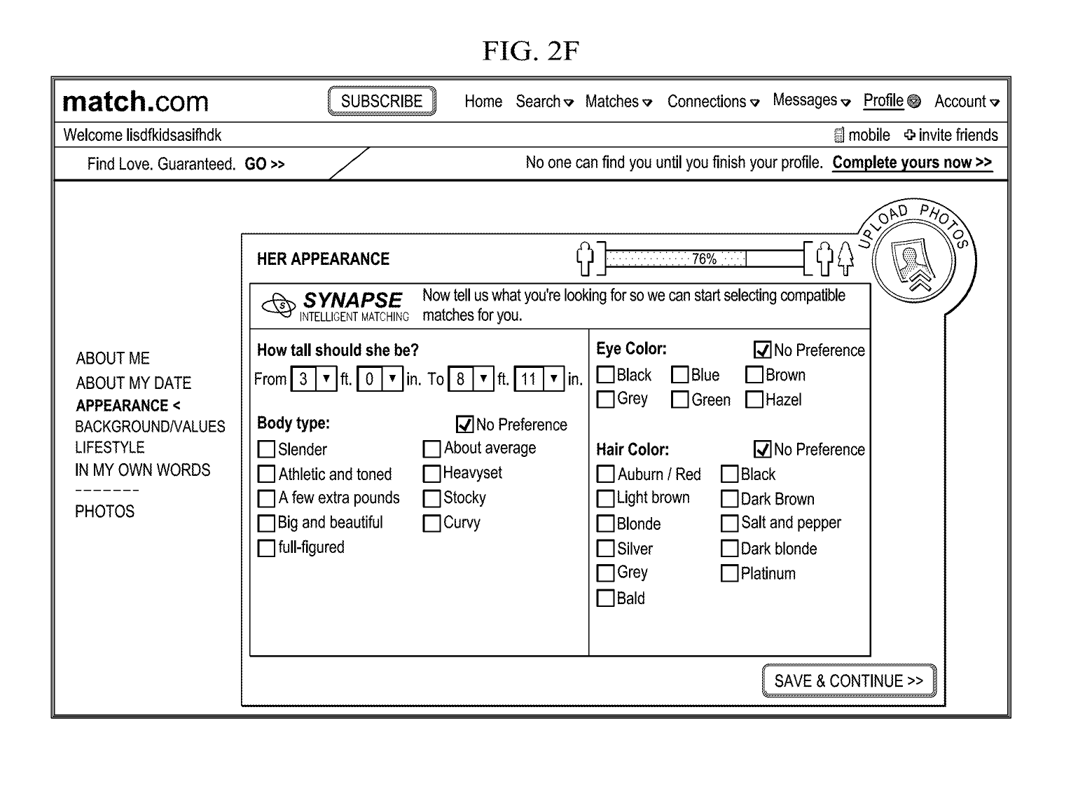

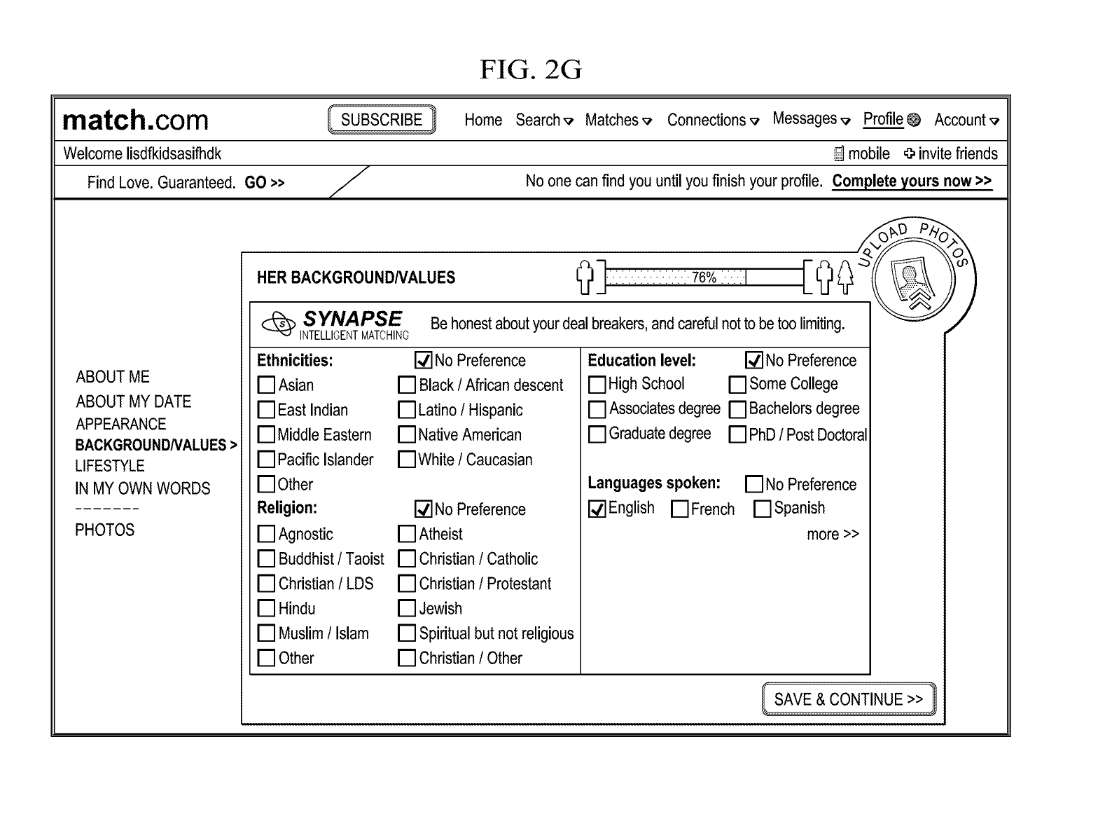

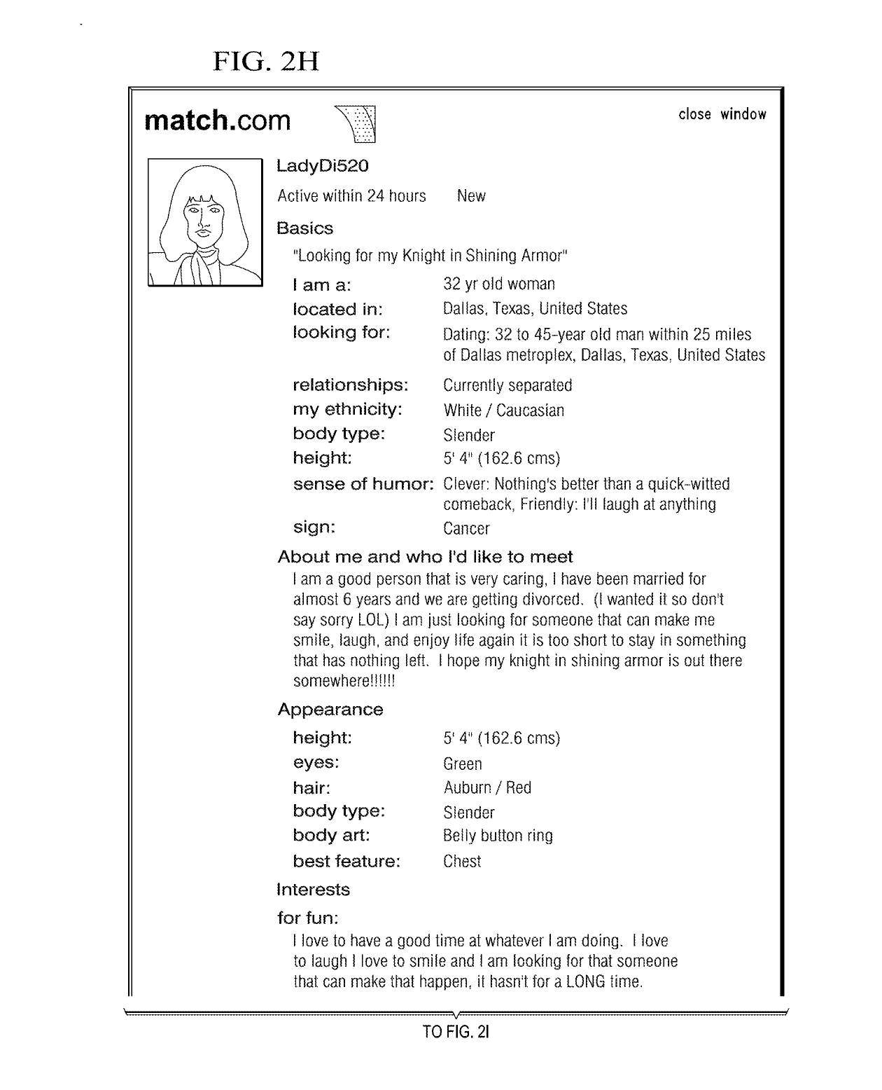

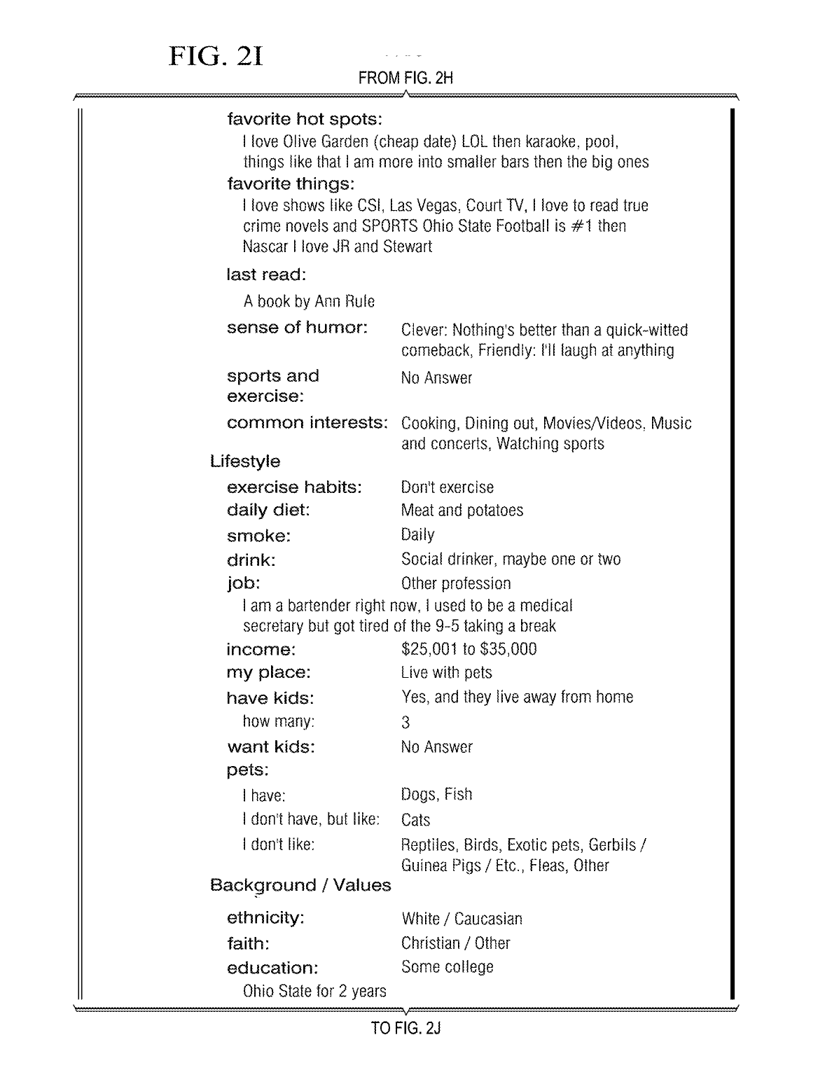

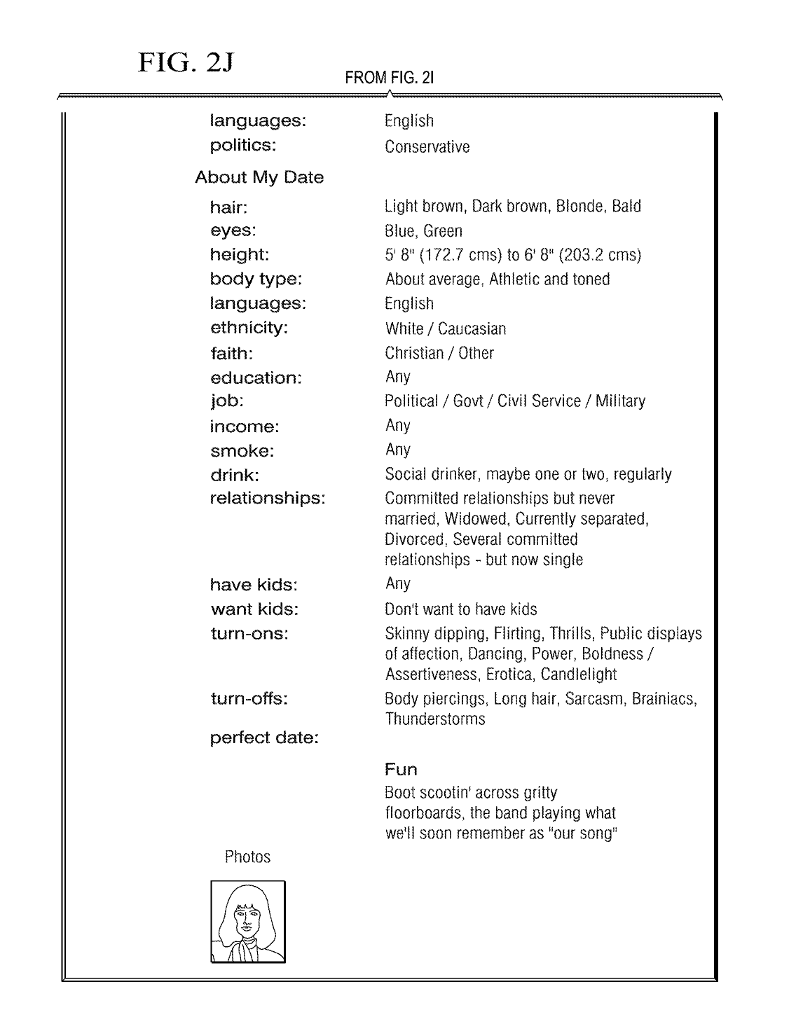

FIGS. 2A-2J illustrate example screen shots that may be provided in the online dating process to facilitate presentation of information to and gathering of information from member end users. FIGS. 2A-2J are presented herein for purposes of discussion. It is imperative to note that these illustrations are only being provided to further outline a particular implementation of the present disclosure. In no way should these diagrams be used to limit or to restrict the broad teachings of the present disclosure. Such illustrative information has been offered earnestly and, thus, should not be construed to confine the broad applications of the present disclosure.

FIG. 2A is an example screen shot of a home page from which an interested end user may begin his/her journey. In the illustrated example, the home page solicits location information, such as a city or zip code, as well as an indication of the end user's gender and an age range and gender preference of persons the end user is interested in “meeting” via system 10. Subsequent to the end user's completion of the requested information and clicking on a “How it Works” icon on the home page of FIG. 2A, a screen shot as shown in FIG. 2B is presented to the end user. The screen shot of FIG. 2B provides a generic outline of the online dating process. As outlined in the screen shot of FIG. 2B, as a first step, an end user may choose to browse the website to view pictures of members along with summaries of the members' profiles. After browsing the website, the end user may decide to create a free profile. Once the end user browses the website and creates a profile, the end user may opt to subscribe to the service and receive information from/about others who are part of the online community. For purposes of example and ease of explanation, it will be assumed for the remainder of the discussion of FIGS. 2A-2D that the potential new end user investigating and ultimately subscribing to the service is a male named “Tom” who is interested in finding a female match.

FIG. 2C is an example screen shot of a number of profiles that may be viewed by Tom during the browsing phase described above. In the context of this shot, Tom may be simply browsing. Assuming Tom has decided he would like to know more about one of the members whose profile is presented in FIG. 2C, he may click on the picture associated with the selected profile. For example, assuming Tom has decided he would like more information about “LadyDi520”, clicking on her picture results in his being directed to a web page as shown in FIG. 2D, where he is solicited to sign up for the online dating subscription such that he can effectively contact his candidate selection. It will be noted that the information solicited using the page shown in FIG. 2C may be used in selecting matches for Tom. The information may also be displayed on Tom's profile or summary thereof presented to other users to assist those users in determining whether they are interested in interacting with him.

FIGS. 2E-2G illustrate various screen shots comprising a user information collection process in accordance with one embodiment. Using the web pages illustrated in FIGS. 2E-2G, system 10 collects a variety of information from an end user, including, but not limited to, basic information about the end user (FIG. 2E), as well as information about the type person the end user would be interested in dating, including information about a potential date's physical appearance (FIG. 2F) and background and values (FIG. 2G). It will be recognized that the information collected using the web pages illustrated in FIGS. 2E-2G is illustrative only and that any type/amount of information may be solicited in the illustrated manner.

FIGS. 2H-2J are example screen shots of the full profile of LadyDi520, the picture Tom selected while browsing. In illustrated profile, LadyDi520's match criteria are displayed, as well as other information that may be pertinent to a potential mate. Any suitable items can be provided in such a profile (such as interests, favorite hot spots, favorite things, desire for children, background, etc.). Virtually any type or format of information (inclusive of video and audio data) may be provided in such a profile. In particular, the profile includes information that was solicited from LadyDi520 when she set up her online dating account. The profile may include a photo, biographical information (e.g., gender, age, location, relationship status, etc.), physical information (e.g., height, weight, hair and eye color, etc.), interests (e.g., hobbies, “favorites,” etc.), lifestyle information (e.g., exercise habits, employment, smoking/drinking habits, etc.), and background/values (e.g., ethnicity, faith, education, etc.). The profile may also include a section entitled “About My Date,” in which the end user specifies preferences about the type of person he/she would like to meet/date (e.g., appearance, interests, faith, education, relationship goals, etc.). In some embodiments, a full profile, including the profile information provided by the end user and stored in the system, is displayed to interested viewers; in other embodiments, only a summary or subset of the profile information is displayed.

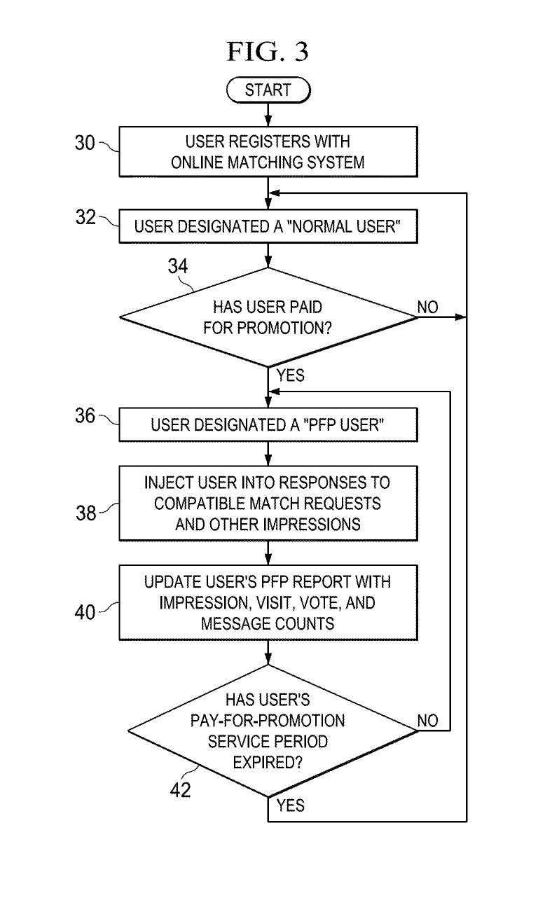

In one embodiment, the system 10 may include a feature referred to herein as a pay-for-promotion (“PFP”) feature. As will be described in greater detail below with reference to FIGS. 3-5, one objective of the PFP feature is to optimize the number of times the profile of a user who activates the PFP feature is promoted, or meaning that the number of times/places in which the user's profile is displayed on the website is boosted, or increased. As used herein, the terms promoting and boosting refer to displaying some portion of the user's profile (such as name, picture, etc.) in a manner that it is more likely to be noticed, and perhaps selected, by other users. For example, the profile may be positioned at or near the top of a list of matches, presented in a featured area of the website, and/or presented to other users in ways that do not require the other users to exercise much, or any, effort to view the profile. In one embodiment, when a user activates the PFP feature, e.g., by paying a specified amount for a designated period of time during which his/her profile will be promoted (such a user will hereinafter be referred to as a “PFP user”), the system 10 may intelligently inject the PFP user's profile into various locations and scenarios within the website 22.

It may be understood that different users may trust different sources of profiles within the system 10; accordingly, in accordance with features of one embodiment, the PFP feature may accommodate these source preferences by injecting the profile of PFP users in a variety of different locations on the website. In some embodiments, the selection of where to inject the PFP user's profile may be dependent upon the particular user accessing the website at the time, based on that user's preferences for locating matches. To illustrate, it will be assumed for the sake of example that UserA is a PFP user and UserB and UserC are other users of the system 10. It will be further assumed that UserB typically prefers to interact with other users he or she discovers through tailored searches, while UserC often clicks on the user profiles presented in a certain area of the website (e.g., “Featured Users”). In accordance with features of certain embodiments, the profile of UserA will be included at the top of search results provided to UserB (assuming, of course, that UserA is indeed a match for UserB as determined by the search algorithm being implemented in the system 10), while the profile of UserA will be presented in the “Featured Users” list presented to UserC.

In another aspect, promotion of PFP users is carefully monitored to avoid oversaturation in the various locations. Using the example above to illustrate this point, if UserA is presented at the top of every set of search results returned to UserB, at some point, UserB will be less interested and more apt to ignore UserA's profile than if UserA appears in only some sets of search results. In yet another aspect of the promotional algorithm, the amount of attention that is being paid to a PFP user's profile is monitored. A first impression threshold, which is indicative of the number of times a user would ideally be presented with the PFP user's profile, is set and the number of visits for the particular profile is targeted. A control framework is used and is based on a thermostat model that regulates visits to the PFP user's profile page and impressions given to the profile. A second level for the control framework operates by modifying the impression threshold in order to accomplish the designated visit target. As a result, a built-in correctional system is provided for the pay-for-promotion feature. As used herein, an “impression” is any time a promoted user is shown because of the promotion. An impression could occur in various areas of the site, including match results, a list of recommended profiles, etc. A “visit” occurs when a user opens, accesses, clicks on, views, or otherwise interacts with or evinces an intent to interact with another user or the user's profile via the system.

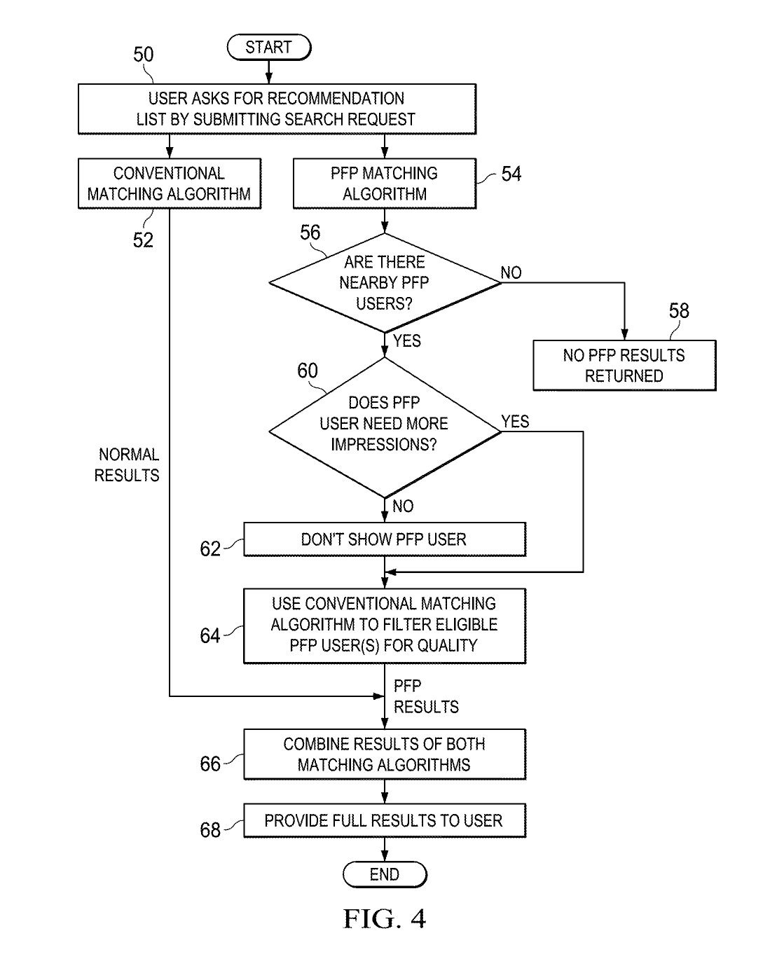

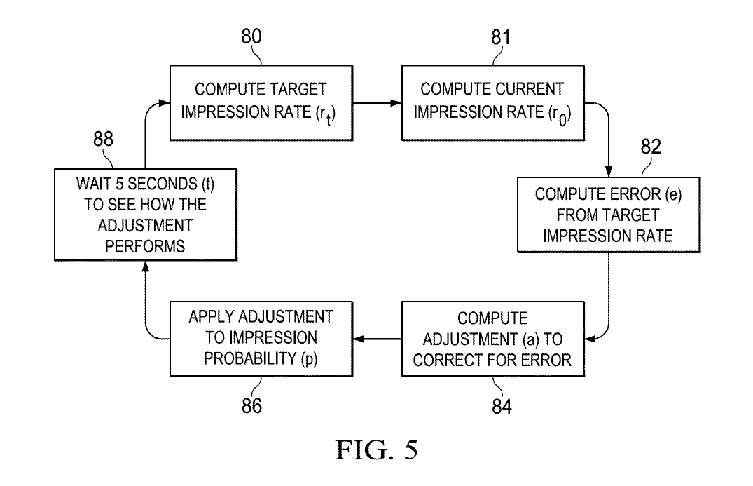

FIG. 3 illustrates a flowchart of operation of the PFP feature described herein. In step 30, a user registers with the system 10, for example, in a manner such as that described above in connection with FIGS. 2A-2G. Initially, as illustrated in step 32, the user is deemed a “normal user.” In step 34, a determination is made whether the user has paid to activate the PFP feature for a period of time. It will be recognized that the user may choose to pay a first amount to be promoted, or boosted, for a first period of time or a second (greater) amount to be promoted, or boosted, for a second (longer) period of time. The user's account will be charged for the selected level service. If it is determined in step 34 that the user has not paid to activate the PFP feature, execution returns to step 32 and the user remains a “normal user” until he or she pays to activate the PFP feature. If it is determined in step 34 that the user has paid to activate the PFP feature, in step 36, the user is deemed a “PFP user.” In step 38, the PFP user is injected into search results for compatible match requests, as described in greater detail below with reference to FIG. 4. Additionally, the PFP user may be promoted in other ways by providing other impressions in various areas of the website. In step 40, a “PFP report” maintained for the PFP user is updated to reflect the number of impressions, visits, votes, and received messages that occur during the PFP period. In step 42, a determination is made whether the time period for which the PFP user paid for PFP service has expired. If not, execution returns to step 36 and the PFP user continues to be promoted in accordance with controls described below in FIGS. 4 and 5; otherwise, execution returns to step 42 and the user must once again pay if he or she would like to take advantage of the PFP feature once again.

FIG. 4 is a flowchart illustrating injection of a PFP user into other users' search results (e.g., step 38 in FIG. 3). In step 50, a user (other than the PFP user) submits a match request to the system 20. In one embodiment, this initiates two different matching algorithms. The first matching algorithm is a conventional matching algorithm performed by the system 10, which basically comprises searching user profiles that match, to some degree, search criteria provided by the user. This is represented in step 52. Additionally, in accordance with features of embodiments described herein, a PFP matching algorithm is also initiated, as represented in steps 54-64. Specifically, in step 56, a determination is made whether there are any PFP users that are geographically proximate the user who initiated the search in step 50. If not, no PFP results are identified for presentation to the user (step 58). In contrast, if it is determined in step 56 that there are PFP users geographically proximate the user who initiated the search, in step 60, a determination is made, for each of the geographically proximate PFP users, whether the PFP user needs more impressions. For each of the identified PFP users, if a negative determination is made in step 60, the PFP user is not included in the search results returned to the user (step 62). In contrast, if a positive determination is made in step 60, meaning that there is no danger of oversaturation with respect to the PFP user at this point in time, in step 64, the PFP user is subjected to the same filtering provided by the conventional matching algorithm (step 52) to determine whether the PFP user is indeed a match. In step 66, normal results and PFP results are combined and in step 68, the combined results are presented to the user.

FIG. 5 illustrates a promotion impression controller loop in accordance with embodiments described herein. In step 80, a target impression rate (in terms of number of impressions over some unit of time, for example) is calculated. In step 81, a currently observed impression rate for a particular time period is calculated. In step 82, an error factor, indicative of a distance between the currently observed impression rate and the target impression rate, is calculated. In step 84, an adjustment to correct for the error factor calculated in step 82 is calculated. In step 86, the adjustment calculated in step 84 is applied to an impression probability, which represents the probability that user will get shown in impressions in which they are eligible to be shown. In step 88, a time t (e.g., five seconds) is waited to see how the adjustment applied in step 86 performs. Execution then returns to step 80 and cycles through again.

As described in greater detail below, the promotion impression controller loop illustrated in FIG. 5 updates an impression probability p at a time t based on observed impression counts at p at time t−1. p(0) is set to a default probability, such as 0.5.

Variables and constants used by the promotion impression controller loop shown in FIG. 5 are set forth below:
g: gain (how quickly and strongly errors are compensated for in the impression rate);
c_{f}: correction for floating point overflow (an extremely small number (1e⁻⁶, for example));
a: adjustment (how much p Is tweaked (or adjusted) to correct for e);
t: current time in the promotion impression controller loop;
s: number of seconds over which impression rate data is collected;
rₜ: target impression rate to achieve the desired number of impressions;
rₒ: observed current impression rate (e.g., impression rate over the last s seconds);
iₜ: target number of impressions for the promotion period;
number of impressions used since the promotion began;
iᵤ: number of impressions observed in the past s seconds;
tₚ: total promotion time for the PFP user;
tᵤ; time used so far;
e: error factor or distance between current impression rate and target impression rate as a multiplicative factor; and
p(t): the probability that a user gets shown in an impression where they are eligible to be shown (this is controlled to achieve the desired number of impressions).

In one embodiment, the following equation may be used to calculate the target impression rate (rₜ) in step 80:

rₜ=(iₜ−iᵤ)/(tₚ−tᵤ)

In one embodiment, the following equation may be used to calculate the impression rate that has been recently observed (rₒ) in step 81:

rₒ=iₒ/s

Thereafter, in step 82, if rₒ>rₜ, then the error e may be calculated using the following equation:

e=(rₜ−rₒ)/(rₜ+c_{f})

Otherwise, the error e may be calculated as:

e=(rₜ-rₒ)/(rₒ+c_{f})

In step 84, the adjustment a may be calculated using the following equation:

a=1+e*g

And finally, in step 86, the adjustment may be applied to the impression probability using the following equation:

p(t)=p(t−1)*a

As illustrated in FIG. 5, the above equations executed in a tight loop (once every five seconds, for example) to keep p up to date with new information about how well it is achieving the target number of impressions.

The impressions controller can be summed up as adjusting p(t) to achieve a desired iₜ. Looking at the impressions controller as a black box, iₜ is its input, and p(t) is its output. As time goes on and conditions change, the impressions controller adapts p(t) to achieve the impressions goal. The PFP system endeavors to deliver a target number of visits to the promoted user. Since the impressions controller is only able to achieve the target number of impressions and not a target number of visits, a second controller is needed to achieve the goal. A second controller, called the visits controller, functions in a way that is identical to the impressions controller. The visits controller receives a target number of visits to achieve during the promotion as its input, and delivers a number of impressions needed to achieve that target. That number of impressions is then fed into the impressions controller, which adapts p(t) to target the new impression goal. In this way, the two controllers work together and adapt to achieve a target number of visits only by tweaking p(t). Having two controllers allows the system as a whole to adapt quickly to changes in the number of available impressions (handled by the impressions controller) and still deal productively with the slow, inconsistent feedback provided by monitoring the number of visits a user is receiving (handled by the visits controller).

Although the present disclosure has been described in detail with reference to particular embodiments, it should be understood that various other changes, substitutions, and alterations may be made hereto without departing from the spirit and scope of the present disclosure. For example, although the present disclosure has been described with reference to a dating protocol, any service that deals with (or that leverages) profiles, photos, resumes, user information more generally, etc. could readily benefit from the present disclosure.

Moreover, although the present disclosure has been described with reference to a number of elements included within system 10, these elements may be rearranged or positioned in any appropriate manner to accommodate any suitable networking configurations. In addition, any of the elements of FIG. 1 may be provided as separate external components to system 10 or to each other where appropriate.

It should also be noted that any of the question portions of the platform can leverage any type of format. Thus, in any aspect of the online dating process described herein, such as establishing a personality profile, for example, any suitable question format can be employed. Example formats include a Yes/No format, a multiple choice question format, a short answer format, a true/false format, etc. Other formats can readily be used in order to achieve the desired responses and solicit the appropriate data.

Note that in certain example implementations, the matching functions outlined herein, such as those carried out by web server 16 and/or provided as an application for an endpoint being operated by an end user (e.g., a mobile application for an iPhone™), may be implemented by logic encoded in one or more non-transitory, tangible media (e.g., embedded logic provided in an application specific integrated circuit (“ASIC”), digital signal processor (“DSP”) instructions, software (potentially inclusive of object code and source code) to be executed by a processor, or other similar machine, etc.). In some of these instances, a memory, as shown in FIG. 1, can store data used for the operations described herein. This includes the memory being able to store software, logic, code, or processor instructions that are executed to carry out the activities described in this Specification.

A processor can execute any type of instructions associated with the data to achieve the operations detailed herein in this Specification. In one example, the processor, as shown in FIG. 1, could transform an element or an article (e.g., data) from one state or thing to another state or thing. In another example, the activities outlined herein may be implemented with fixed logic or programmable logic (e.g., software/computer instructions executed by a processor) and the elements identified herein could be some type of a programmable processor, programmable digital logic (e.g., a field programmable gate array (“FPGA”), an erasable programmable read only memory (“EPROM”), an electrically erasable programmable ROM (“EEPROM”)) or an ASIC that includes digital logic, software, code, electronic instructions, or any suitable combination thereof.

These devices illustrated herein may maintain information in any suitable memory (random access memory (“RAM”), ROM, EPROM, EEPROM, ASIC, etc.), software, hardware, or in any other suitable component, device, element, or object where appropriate and based on particular needs. Any of the memory items discussed herein should be construed as being encompassed within the broad term “memory.” Similarly, any of the potential processing elements, modules, and machines described in this Specification should be construed as being encompassed within the broad term “processor.” Each of the network elements can also include suitable interfaces for receiving, transmitting, and/or otherwise communicating data or information in a network environment.

Note that with the example provided above, as well as numerous other examples provided herein, interaction may be described in terms of more than one network element. However, this has been done for purposes of clarity and example only. In certain cases, it may be easier to describe one or more of the functionalities of a given set of flows by only referencing a limited number of network elements. It should be appreciated that system 10 (and its teachings) are readily scalable and can accommodate a large number of components, as well as more complicated/sophisticated arrangements and configurations. Accordingly, the examples provided should not limit the scope or inhibit the broad teachings of system 10 as potentially applied to a myriad of other architectures.

It is also important to note that the steps in the preceding flow diagrams illustrate only some of the possible signaling scenarios and patterns that may be executed by, or within, system 10. Some of these steps may be deleted or removed where appropriate, or these steps may be modified or changed considerably without departing from the scope of the present disclosure. In addition, a number of these operations have been described as being executed concurrently with, or in parallel to, one or more additional operations. However, the timing of these operations may be altered considerably. The preceding operational flows have been offered for purposes of example and discussion. Substantial flexibility is provided by system 10 in that any suitable arrangements, chronologies, configurations, and timing mechanisms may be provided without departing from the teachings of the present disclosure. Although the present disclosure has been described in detail with reference to particular arrangements and configurations, these example configurations and arrangements may be changed significantly without departing from the scope of the present disclosure.

Numerous other changes, substitutions, variations, alterations, and modifications may be ascertained to one skilled in the art and it is intended that the present disclosure encompass all such changes, substitutions, variations, alterations, and modifications as falling within the scope of the appended claims. In order to assist the United States Patent and Trademark Office (USPTO) and, additionally, any readers of any patent issued on this application in interpreting the claims appended hereto, Applicant wishes to note that the Applicant: (a) does not intend any of the appended claims to invoke paragraph six (6) of 35 U.S.C. section 112 as it exists on the date of the filing hereof unless the words “means for” or “step for” are specifically used in the particular claims; and (b) does not intend, by any statement in the specification, to limit this disclosure in any way that is not otherwise reflected in the appended claims.

1. A method comprising:
identifying a user in a computer-implemented matching system as having paid a fee for additional promotion of the identified user during a promotional period; and
during the promotional period, providing impressions for the identified user in accordance with an impression probability calculated to achieve a promotional target with respect to the user, wherein the impressions comprise presenting the identified user to other users in the computer-implemented matching system.

2. The method of claim 1, wherein the promotional target comprises a target number of visits by other users to a profile of the identified user during the promotional period.

3. The method of claim 1, wherein the promotional target comprises a target number of impressions for the identified user during the promotional period.

4. The method of claim 1 further comprising, during the promotional period, updating the impression probability based on an actual number of impressions for the user during a previous time period relative to the promotional target.

5. The method of claim 1 further comprising, upon expiry of the promotional period:
determining whether the user has paid for promotion of the user during an additional promotional period; and
if the user has not paid for promotion of the user during the additional time period, ceasing the providing impressions for the user.

6. The method of claim 1, wherein the providing impressions comprises injecting a profile of the user into search results of other users.

7. The method of claim 1, wherein the providing impressions comprises displaying a profile picture of the user in a featured area of a web page viewed by another user.

8. The method of claim 1, further comprising:
offering a subscription to a website-based service in exchange for a fee, wherein the website is configured to provide one or more results associated with ranking a set of like user profiles.

9. Logic encoded in one or more non-transitory tangible media that includes code for execution and when executed by a processor is operable to perform operations comprising:
identifying a user in a computer-implemented matching system as having paid a fee for additional promotion of the identified user during a promotional period; and
during the promotional period, providing impressions for the identified user in accordance with an impression probability calculated to achieve a promotional target with respect to the user, wherein the impressions comprise presenting the identified user to other users in the computer-implemented matching system.

10. The logic of claim 9, wherein the promotional target comprises a target number of visits by other users to a profile of the identified user during the promotional period.

11. The logic of claim 9, wherein the promotional target comprises a target number of impressions for the identified user during the promotional period.

12. The logic of claim 9 further comprising code that when executed by a processor is operable to perform operations comprising:
during the promotional period, updating the impression probability based on an actual number of impressions for the user during a previous time period relative to the promotional target.

13. The logic of claim 9 further comprising code that when executed by a processor is operable to perform operations comprising:
upon expiry of the promotional period, determining whether the user has paid for promotion of the user during an additional promotional period; and
if the user has not paid for promotion of the user during the additional time period, ceasing the providing impressions for the user.

14. The logic of claim 9, wherein the providing impressions comprises injecting a profile of the user into search results of other users.

15. The logic of claim 9, wherein the providing impressions comprises displaying a profile picture of the user in a featured area of a web page viewed by another user.

16. An apparatus, comprising:
a server that includes a processor and a memory, wherein the apparatus is configured to:
identify a user in a computer-implemented matching system as having paid a fee for additional promotion of the identified user during a promotional period;
during the promotional period, provide impressions for the identified user in accordance with an impression probability calculated to achieve a promotional target with respect to the user, wherein the impressions comprise presenting the identified user to other users in the computer-implemented matching system.

17. The server of claim 16, wherein the promotional target comprises one of a target number of visits by other users to a profile of the identified user during the promotional period and a target number of impressions for the identified user during the promotional period.

18. The server of claim 16 further configured to, during the promotional period, update the impression probability based on an actual number of impressions for the user during a previous time period relative to the promotional target.

19. The server of claim 16 further configured to, upon expiry of the promotional period:
determine whether the user has paid for promotion of the user during an additional promotional period; and
if the user has not paid for promotion of the user during the additional time period, cease the providing impressions for the user.

20. The server of claim 16, wherein the providing impressions comprises at least one of injecting a profile of the user into search results of other users and displaying a profile picture of the user in a featured area of a web page viewed by another user.
